(19) United States
(12) Patent Application Publication
(10) Pub. No.: US 2012/0038362 A1
(43) Pub. Date: Feb. 16, 2012

(54) Method and Apparatus for Offshore Hydrocarbon Electromagnetic Prospecting based on Circulation of Magnetic Field Derivative Measurements

(76) Inventors: Jostein Kåre Kjerstad, Stavanger (NO); Pavel Barsukov, Moscow (RU); Eduard B. Fainberg, Amersfoort (NL)

(21) Appl. No.: 13/256,021

(22) PCT Filed: Mar. 11, 2010
(86) PCT No.: PCT/NO10/00091

§ 371 Date: Oct. 13, 2011

(30) Foreign Application Priority Data
Mar. 12, 2009 (NO) 20091088
Mar. 11, 2010 (NO) 20100343

(51) Int. Cl. G01V 3/12

(52) U.S. Cl. 324/337

(57) ABSTRACT

A system for offshore hydrocarbon electromagnetic prospecting is described. The system includes a transmitter generating electromagnetic energy and injecting an electrical current into a flooded vertical cable. The circulated induced vertical current time derivative's response generated by this current in the medium is measured by a circular chain of magnetometers. The measured response which is sensitive to the resistivity of targets is proposed to be used to search for and identify hydrocarbons reservoirs.

A system for offshore hydrocarbon electromagnetic prospecting is described. The system includes a transmitter which generates electromagnetic energy and injects an electrical current into a vertical, flooded cable. An induced vertical current time derivative's response generated in the medium by this current is measured by a chain of magnetometers. The measured response, which is sensitive to the resistivity of targets, is proposed to be used to search for and identify hydrocarbon reservoirs.

Nowadays, a number of controlled-source electromagnetic (CSEM) methods for hydrocarbon prospecting are known and used. As a transmitter they use either a horizontal electrical cable towed by a vessel (SBL, MTEM, CSEMI and other methods; see for example U.S. Pat. Nos. 4,617,518 and 6,522,146 of Srnka; 5,563,513 of Tasci; 0027130, 0052685, 0048105, 6,859,038, 6,864,684, 6,628,119 of Eidesmo et al.; 2006132137 and 7,337,064 of MacGregor et al., 2008/189042 of Lisitsyn et al.; European patent No. EP 1,425,612 of Wright et al. See also international, publication No. WO03/048812 of MacGregor and Sinha, WO2004049008, GB 2395563, AU 20032855 of MacGregor, and U.S. Pat. No. 6,842,006 of Conti et al., and publications cited in the list of references) or a vertical electrical cable fixed or towed by a vessel (MOSES, TEMP-VEL/TEMP-OEL; see for example Edwards et al. 1981; Edwards et al. 1985; Norwegian patent NO 323889 of Barsukov et al. (equivalent to WO2007/053025 A1) and other publications cited in the references).

The main property of the hydrocarbon target used by all electromagnetic (EM) methods for prospecting is its higher resistivity in comparison with the host rock. As it is known from geoelectrical prospecting theory, maximal sensitivity for such targets is provided by the galvanic mode of EM fields. The galvanic mode can be excited in sea water by a current injected in a vertical subsea cable, as in the MOSES, TEMP-VEL/TEMP-OEL and VESOTEM methods, (Chave et al., 1992; Barsukov et al., 2006; Lisitsyn et al., 2008).

In the TEMP-VEL and TEMP-OEL methods, the vertical electrical field measured by electrodes is used for determining the medium response. The time domain and near zone used in these methods enable sounding in both shallow and deep sea water. TEMP-VEL/TEMP-OEL covers a very wide range of depths and provides the best resolution with respect to the hydrocarbon target. However, they have a disadvantage due to drift and noise inherent in non-polarized electrodes which are usually used in surveying at sea.

In the MOSES method, two horizontal components of the magnetic field are measured in the frequency domain, and the azimuthal component is used for the determination of a medium response. Because of the frequency domain and fast attenuation of the magnetic field, this method has a smaller sounding depth range and lower resolution with respect to a deep-lying target than TEMP-VEL/TEMP-OEL and VESOTEM.

The VESOTEM method operates with two horizontal components of the electrical field registered by non-polarized electrodes on the seabed. The VESOTEM method does not use the vertical component of the electrical field.

In the same way as the MOSES and VESOTEM methods, the TEMP-VEL/TEMP-OEL methods use a vertical electrical conductor connected to a generator. As the response is used, in the TEMP-VEL/TEMP-OEL methods, the vertical component of the electrical field induced in the structure, it being recorded in the pauses between the current pulses. The time domain and the near zone used in the TEMP-VEL/TEMP-OEL methods give a possibility of carrying out soundings in both shallow and deep water. The TEMP-VEL/TEMP-OEL methods thereby cover a wide range of depths and provide an improved resolution with respect to hydrocarbon targets. Because of that, the present invention has the TEMP-VEL/TEMP-OEL methods as its starting point.

It is important to note that all the methods which are based on measuring the electrical field by means of contact electrodes have serious drawbacks that are due to the drift and noise inherent in non-polarized electrodes which are normally used in offshore prospecting.

The most popular SBL method uses a horizontal transmitter cable and horizontal receivers which provide a maximal measured signal; however, they have minimal resolution and depth of sounding.

The invention has for its object to remedy or reduce at least one of the drawbacks of the prior art.

The object is achieved through features which are specified in the description below and in the claims that follow.

An invention has been provided, combining a vertical electrical cable as the transmitter, measurements in the near zone of the time domain and circulation of the time derivative of an azimuthal component of magnetic induction in an advantageous way in relation to the prior art.

In the proposed invention are used a vertical electrical cable as transmitter, measurements in the near zone of the time domain and circulation of the time derivative of the azimuthal component of the magnetic field, and a possibility of combining all the advantages of the TEMP-VEL/TEMP-OEL and MOSES methods in a new method is thereby provided.

Measurements of the vertical component of an electrical field E_{z} are usually produced either by a simple vertical electrical cable in sea water, which is terminated by electrodes, or by an electric sensor of a special construction (Constable, 2005, 2008) in direct contact with sea water.

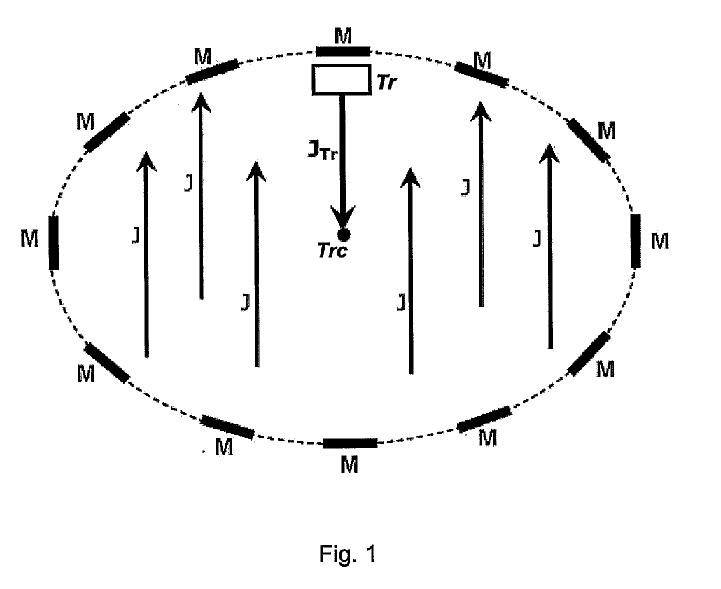

In the real invention, the transient of a vertical current induced in the medium is proposed to be measured instead of the vertical electrical field used in the TEMP-VEL/TEMP-OEL and VESOTEM methods and other methods. A large, toroidal coil or a circular chain of induction-coil magnetometers is proposed to be used for such measurements. A sketch of such a system is shown in FIG. 1. Without electrodes, such a system measures the circulations of the time derivative of the azimuthal component of the magnetic induction, and this corresponds to the time derivative of the vertically directed electrical current.

The general scheme of the surveying process is as follows:
A vessel is moved over the profile or the area that is thought or known to contain a subterranean hydrocarbon reservoir. The surveying is carried out according to a start-stop regime.
When the vessel has arrived at a particular point, the vessel and auxiliary ships install the large, toroidal coil or the system of induction-coil magnetometers on the sea floor along radial lines, at a distance around the transmitter point. All the magnetometers are oriented perpendicularly to the radial lines in order to provide measurements of

$${L}_{} ( d {B}_{ϕ} / d t ) d lt ,$$

that is to say, circulation of the time derivative of the azimuthal component of a magnetic field B_{φ} along a circular contour L around the vertical transmitter cable; this circulation determining the time derivative of the total vertical current through the area inside the contour (see FIG. 1).
Then, the vessel submerges a vertical transmitter cable in the transmitter point and starts injecting sequential series of an alternating current of the step-type form.
The measurements are produced during 20-60 minutes to provide an acceptable signal-to-noise ratio.
The entire system is then moved to another place.

The advantages of the method are achieved by:
a) using the galvanic mode of the electromagnetic field generated by a current impressed on a vertical transmitter cable;
b) measurements of the time derivative of the vertical electrical current at times and distances satisfying the near-zone condition: 0≦R<<(2πtρₐ/μ₀)^{1/2}, in which t is a time elapsed after switching off the nearest pulse of the transmitted current; μ₀=4π10⁻⁷ H/m; and ρₐ is the apparent resistivity of the substratum;
c) determination of the vertical electrical field from the time derivative by circulation and calculation of the EM responses for the section in the time domain with subsequent interpretation.

The main advantages of the invention are as follows:

It is an advantage of the present invention that it provides a method and an apparatus for the EM prospecting of resistive targets in the underground below the sea floor in the area that is thought or known to contain a subterranean hydrocarbon reservoir, based on measurements of circulation of the time derivative of the magnetic field excited in the medium by a vertical transmitter current.

Another advantage of the present invention is the provision of a method for detecting and tracing EM anomalies stipulated by reservoirs by the use of non-contact measurements of circulation of the time derivative of a vertical electrical current induced in the medium by current pulses from a vertical transmitter.

Another advantage of the present invention is the provision of a method for constructing a comprehensive image of resistivity ρ(x,y,h) of reservoir geometry in the horizontal and vertical directions on the basis of transformations and 1D inversion of the measurements of circulation of the time derivative of the magnetic field excited in the medium by vertical transmitter current pulses.

In one aspect of the invention, a transmitter fixed in some site within the area thought or known to contain a subterranean hydrocarbon reservoir injects current pulses into a vertical cable embedded in sea water. At least one toroidal receiver placed on the sea floor at some distance (offset) from the transmitter makes measurements of the circulation of the time derivative of the azimuthal component of the magnetic field induced in the medium.

Alternatively, a transmitter fixed in some site within the area thought or known to contain a subterranean hydrocarbon reservoir injects current pulses in a vertical cable embedded in sea water. A plurality of the receivers fixed on the sea floor in points equidistant from the transmitter are arranged to strictly synchronously produce measurements of circulation of the time derivative of the magnetic field induced in the medium.

In yet an alternative, a transmitter fixed in some site generates pulses of an electrical current. The measurements of the circulation of the time derivative of the magnetic field in one or a plurality of points are carried out in the near zone during time lapses between consecutive pulses.

The measurements of circulation of the time derivative of the magnetic field are used to determine the section's response and following its tracing, transformation, inversion and mapping of 3D image of a hydrocarbon reservoir.

In its first aspect, the invention relates more specifically to a system for the electromagnetic investigation of a hydrocarbon reservoir below a sea floor, including a controlled-source electromagnetic transmitter provided with a vertical transmitter cable arranged to be submerged in a mass of water and arranged to provide an electromagnetic field by the emission of step-type current pulses; and a plurality of sea-floor receivers arranged on the sea floor above a structure which is thought or known to contain a subterranean hydrocarbon reservoir, characterized by each sea-floor receiver being provided with a recorder device comprising a magnetometer which is arranged to provide a signal in response to the electromagnetic field induced by the transmitter, and a resistivity meter which is arranged to measure the specific sea-water resistivity; and the system further including signal-processing means which are arranged to receive and process a signal from each of the receivers, the signal characterizing, at least in part, the apparent resistivity and the resistance of the reservoir.

The transmitter may be mounted on a vessel and is arranged to be moved, together with the sea-floor receivers, from one site to another above the structure that is thought or known to contain the subterranean hydrocarbon reservoir.

Each receiver may include a resistivity meter.

Each magnetometer may be provided with a clocking device which is arranged in a magnetometer housing and is arranged to provide a timing signal for synchronization and for use in signal processing and stacking.

The transmitter may be arranged to emit intermittent current pulses having sharp edges, and the signal-processing means are arranged to produce time derivatives of magnetic field responses during a time lapse between two consecutive pulses, with accuracy sufficient to distinguish between signal responses when the structure does contain a reservoir and when the structure does not contain a reservoir.

A horizontal distance (offset) between the transmitter cable and any one of the sea-floor receivers, the duration of current pulses and time lapses may be selected in combination with the intensity of the transmitted energy and the expected electrical properties of the water mass, the structure and the reservoir to satisfy the validity of the near zone condition R<<\sqrt{tρₐ(t)/μ₀}, in which R is the distance (offset), t is the time lapse delay counted from the moment after switching off the transmitter, μ₀=4π·10⁻⁷ H/m; ρₐ(t) is the apparent resistivity of the substratum for the time lapse.

The preferred duration of the electric current pulses may fall within the range of 0.01 s to 100 s.

The preferred horizontal distance (offset) between the transmitter cable and any one of the receivers may be in the range of 100-2000 metres.

All the receivers may be installed equidistantly from and around the transmitter cable and are oriented in the azimuthal direction.

All the receivers may be arranged to work synchronously with the transmitter.

Each magnetometer may be arranged to measure the time derivative of the magnetic field.

The magnetometer can be an induction-coil magnetometer.

The signal-processing means may be arranged to produce a calculation of circulation of the time derivative of the magnetic field along the circle of the receivers surrounding the transmitter cable.

In a second aspect, the invention relates more specifically to a method of marine sub-sea-floor hydrocarbon electromagnetic prospecting, characterized by including the steps:
a) deploying a vertically elongated electrical transmitter cable, which is attached to a transmitter, in a water mass above a structure that is thought or known to contain a subterranean hydrocarbon reservoir;
b) distributing a plurality of receivers, each including a magnetometer which is arranged to provide a signal in response to the electromagnetic field induced by the transmitter, on a sea floor at a distance from and around the transmitter cable;
c) obtaining from each receiver the total magnetic field responses of electromagnetic fields excited by the transmitter;
d) accumulating, processing and storing response functions relating to signals from the transmitter and characterizing electrical properties of the structure; and
e) analysing the measured data with the objective of searching for and identifying the hydrocarbon reservoir.

Each receiver may include a resistivity meter.

Each receiver may include a clocking device which provides an accurate timing signal for the synchronization of all the receivers with the transmitter.

The transmitter can emit intermittent current pulses having sharp edges, and the receivers on the sea floor can produce measurements of the medium responses during time lapses between consecutive pulses.

The distance (offset) R between the transmitter cable and any one of the receivers on the sea floor, the duration of current pulses and time lapses t are selected to satisfy the validity of the near zone condition R<<\sqrt{tρₐ(t)/μ₀}, in which μ₀=4π·10⁻⁷ H/m; ρₐ(t) is the apparent resistivity of the substratum, whereas the intensity of the transmitted current is selected to provide the reliable signal sufficient for measurements and inversion of responses when the reservoir is present in and when the reservoir is absent from the structure.

The preferred duration of the electric current pulses may fall within the range of 0.01 s to 100 s.

The distance (offset) between the transmitter cable and any one of the receivers on the sea floor may be in the range of 100-2000 metres.

All the magnetometers on the sea floor may be installed equidistantly from, and along a circle surrounding, the transmitter cable.

All the magnetometers may be installed on the sea floor and are oriented to measure an azimuthal component of the time derivative of the magnetic field.

All the magnetometers on the sea floor may work synchronously with the transmitter.

A data-logging process may provide measurements of the transient process of circulation of the time derivative of the azimuthal component of the magnetic field along a circular contour surrounding the vertical transmitter cable positioned in the centre of this contour.

All the measurements of the transient process, including the time derivative and circulation of the magnetic field, may be accumulated.

The method may further include sea-water resistivity measurements.

The accumulated transient process of circulation of the time derivative of the azimuthal component of the magnetic field may be transformed into apparent-resistivity curves by the use of asymptotical formulas. Alternatively, the accumulated transient process of circulation of the time derivative of the azimuthal component of the magnetic field may be transformed into apparent-resistivity curves by the use of a response function calculated numerically for a normal base cross-section model with the real parameters of system configuration.

The time derivative of the magnetic field, its circulation and the apparent-resistivity curves may be used to image 1D, 2D and 3D models of the reservoir.

The understanding of the present invention will be facilitated when the following detailed description of a preferred embodiment of the present invention is considered together with the accompanying drawings, in which

FIG. 1 is the scheme of sensor installation according to the present invention. Tr is a location in which a vessel with a subsea vertical transmitter cable transmits a current J_{Tr}. J (thin arrows) is a vertical induced current excited in the medium by the J_{Tr} current. M is an induction-coil magnetometer intended to measure an EM response. All the magnetometers M form a circular chain C (dashed line) and make measurements of the time derivative of the total vertical current J.

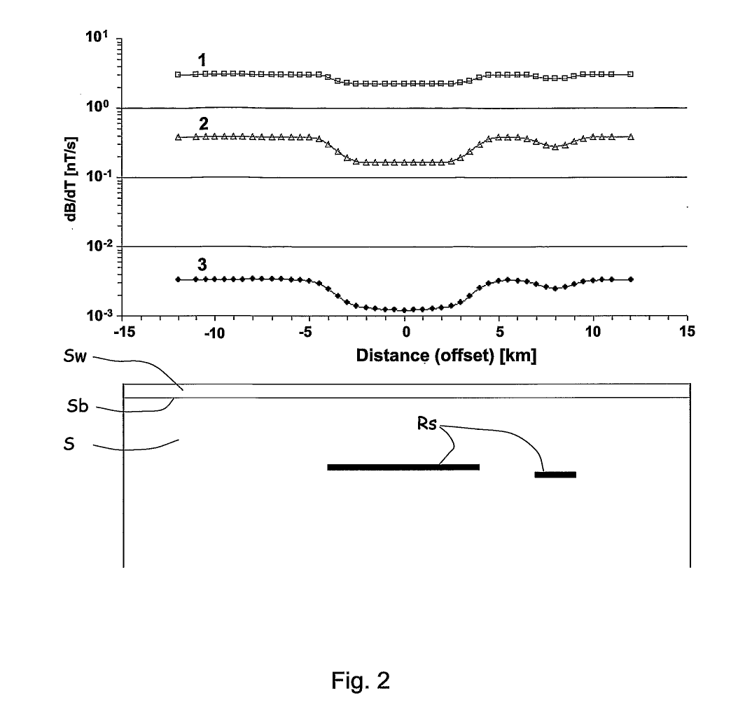

FIG. 2 illustrates the sensitivity and the spatial resolution of the method. Parameters of the model are as follows: two 3D reservoirs Rs of a parallelepiped form are located at 1400 m and 1440 m depth under the sea floor; the widths of the reservoirs are 9 km and 2 km, the length is 12 km. The sea depth and the length of the transmitter cable are 320 m; the resistivity of the sea-water, sediments and reservoirs is 0.3 Ωm, 1 Ωm, and 100 Ωm, respectively; the thickness and the resistivity of the reservoirs are 40 m and 50 Ωm, respectively. The intensity of the transmitter current is 500 A. The curves 1, 2, 3 correspond to delays t=0.5 s, 1 s and 5 s, respectively.

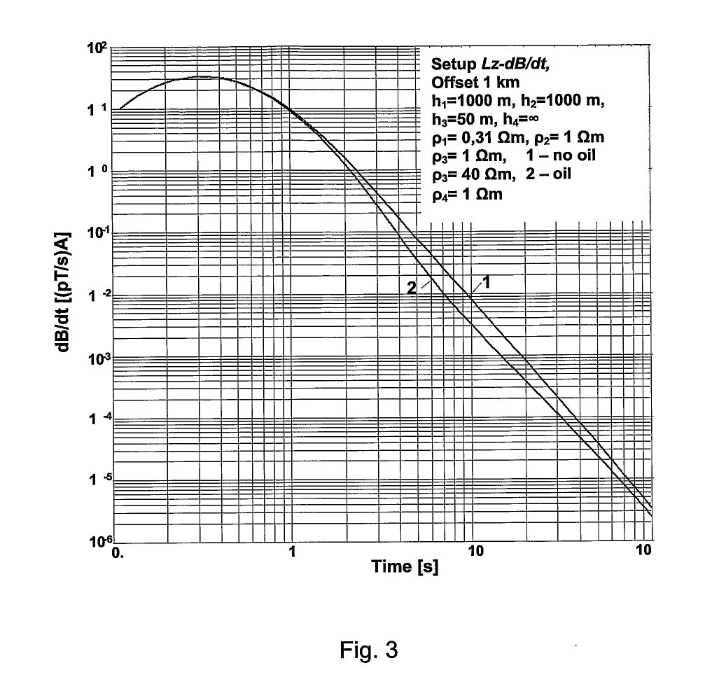

FIG. 3 shows, normalized on the current, the time derivative of the azimuthal component of the magnetic field dB_{φ}/dt versus time for a 1D four-layer structure excited by series of step-type current pulses transmitted through a vertical transmitter cable, 300 m long. Parameters of the cross-section: h₁=300 m (sea water), h₂=1000 m (sediments), h₃=50 m (reservoir), h₄=∞, ρ₁=0.31 Ωm, ρ₂=1 Ωm, ρ₃=1 Ωm (2—oil) or 40 Ωm (1—no oil), ρ₄=1 Ωm. The offset (distance between the transmitter and the receiver) is equal to 1000 meter.

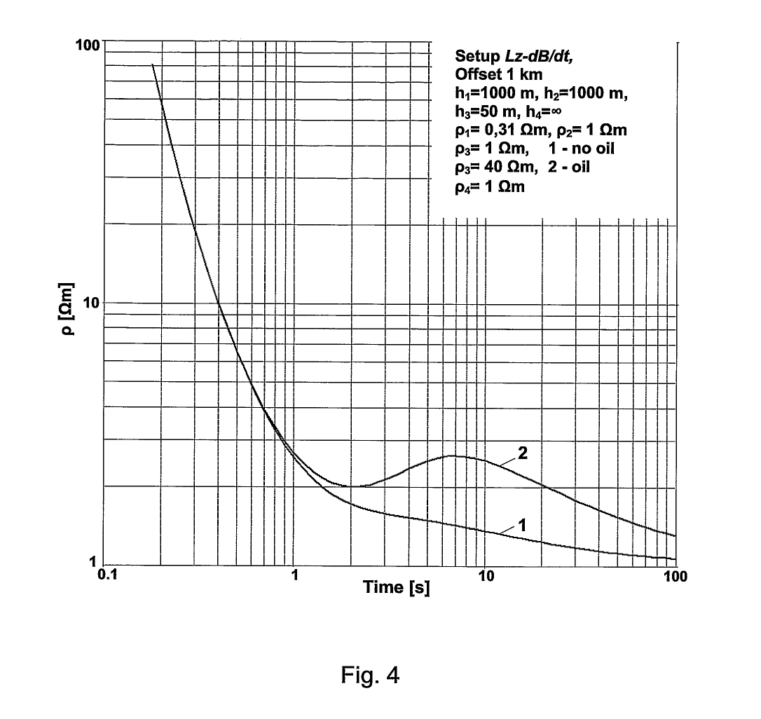

FIG. 4 illustrates the apparent-resistivity curve ρ corresponding to the response presented in FIG. 3.

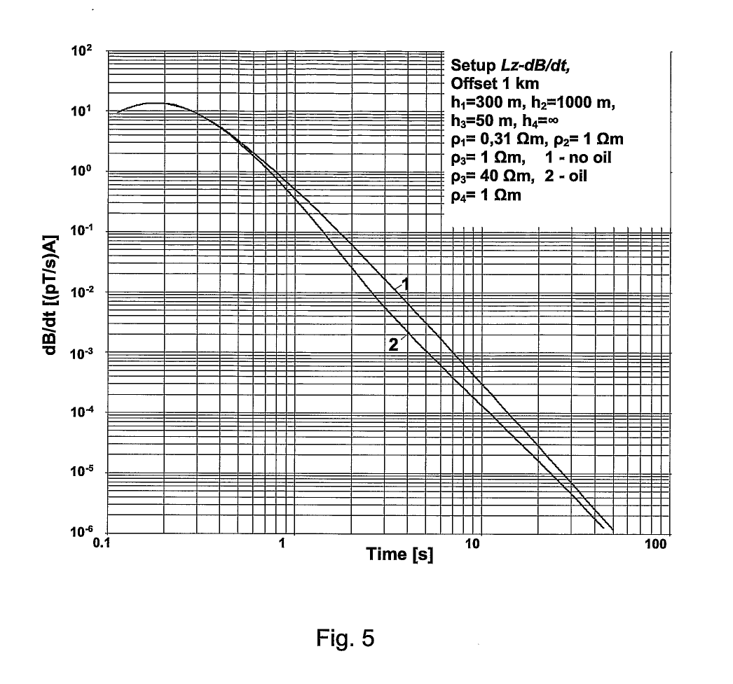

FIG. 5 shows, normalized on the current, the circulation of time derivate of the azimuthal component of the magnetic field dB_{φ}/dt versus time for a 1D four-layer structure excited by series of step-type current pulses transmitted through the vertical transmitter cable, 300 m long. Parameters of the cross-section: h₁=1000 m (sea water), h₂=1000 m (sediments), h₃=50 m (reservoir), h₄=∞, ρ₁=0.31 Ωm, ρ₂=1 Ωm, ρ₃=1 Ωm (2—oil) or 40 Ωm (1—no oil), ρ₄=1 Ωm. The offset (distance between the transmitter and the receiver) is equal to 1000 meters.

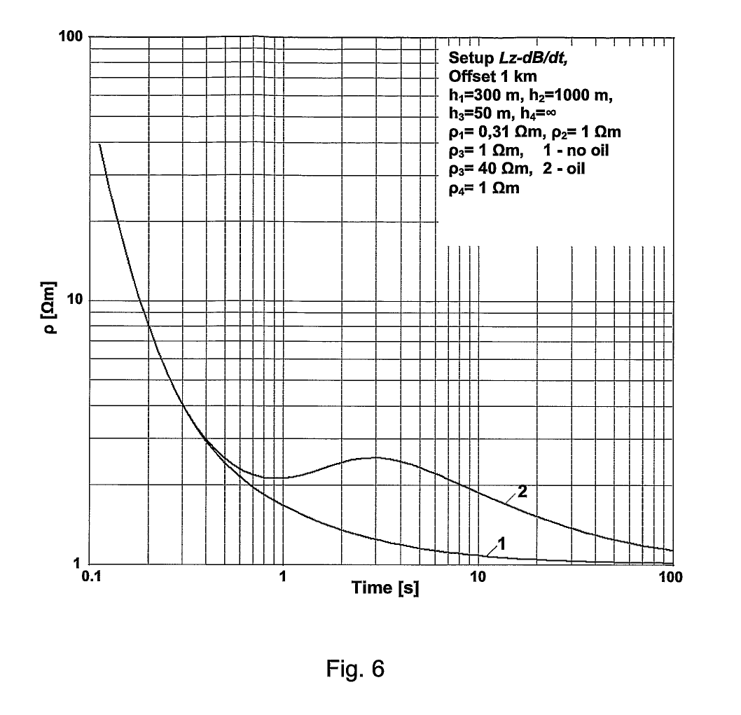

FIG. 6 illustrates the apparent-resistivity curve ρ corresponding to the response presented in FIG. 5.

All existing electromagnetic methods applied for hydrocarbon prospecting use the fact that any reservoir containing oil or gas has higher electrical resistivity in comparison with a reservoir containing water and overburden layers. The maximum resolution of any sounding method is achieved by applying an electrical field that crosses the reservoir body (the TM mode of the field); a magnetic field is less sensitive to hydrocarbon targets because it is produced by an electrical current in the reservoir body which is resistive.

The MOSES method (Edwards et al., 1981, Edwards et al., 1985) and the VESOTEM method (Lisitsyn et al., 2008) use two horizontal components of the magnetic field and two horizontal components of the electrical field, respectively, to determine the response of the section. Using only the vertical electrical field component in both the transmitter and the receiver and measuring signals in the near zone are distinctive characteristics of the principles of the TEMP-VEL/TEMP-OEL method and this distinguishes the TEMP-VEL/TEMP-OEL method from MOSES and VESOTEM.

The most effective existing apparatus applied for hydrocarbon prospecting consists of a transmitter emitting electrical current in the vertical direction, and a receiver measuring the vertical electrical field induced in the medium. Such a configuration is used in the TEMP-VEL and TEMP-OEL methods (NO 323889, Barsukov et al.). However, the technology of measurements of the vertical component of an electrical field (Constable, 2008) is rather difficult and expensive and is complicated by the instability and noise of non-polarized electrodes, which reduces the resolution and depth of investigation.

The circulation of the time derivative of the magnetic field dB/dt measured by a large toroidal coil or a circular chain C of induction-coil magnetometers M is proposed in the invention for the determination of the electromagnetic response. A chain C of synchronously working induction-coil magnetometers M installed on the sea floor Sb symmetrically around the projection of the vertical transmitter cable Trc provides:
stacking of responses and increasing of signal/noise ratio,
averaging of signal distortions caused by local subsurface inhomogeneities,
suppression of noise induced by external geomagnetic variations and artificial sources.

FIGS. 1 and 2 illustrate a first exemplary embodiment of a system according to the present invention. In a subsea structure S (see FIG. 2) extending down from a sea floor Sb are indicated two hydrocarbon reservoirs Rs. Sw indicates a water mass. The system consists of a transmitter Tr mounted on a vessel (not shown) floating in the water mass Sw. The transmitter Tr generates and injects electrical current pulses J_{Tr} into a vertical subsea cable Trc attached to it. A number of induction-coil magnetometers M installed at a horizontal distance (offset) from the transmitter cable Trc measure the response signal dB/dt excited in the medium by the current J_{Tr} on the vertical transmitter cable Trc.

All the induction-coil magnetometers M are installed equidistantly from the transmitter cable Trc and are oriented in the azimuthal direction and each of them are arranged to measure, in the time domain, the dB_{φ}/dt component of the magnetic field during the pauses between sequential current pulses. Circulation of the dB_{φ}/dt along a contour L surrounding the transmitter cable Trc is equal to dJ/dt, in which J is the full vertical electrical current running through the circle L. If the specific sea-water conductivity σ is known, the time derivative of a vertical electrical field can be found as

$$d E / d t = {L}_{} ( d {B}_{ϕ} / d t ) d l / ( {μ}_{0} {σ}_{1} S ) ,$$

in which S is the area of the circle L (shown in FIG. 1 in a dashed line).

Thus, the proposed system provides a method for non-contact, indirect measurements of the time derivative of a vertical electrical field. The difference between the proposed system and other methods consists in the measurements of circulation of the time derivative of magnetic induction dB_{φ}/dt by the system of magnetometers installed equidistantly from, and along a circle surrounding, the vertical transmitter cable.

The function dB_{φ}/dt versus coordinates x, y can be used directly for EM profiling over an area that is thought or known to contain a subterranean hydrocarbon reservoir. Examples of such profiling are shown in FIG. 2.

Even though EM sounding can be fulfilled by a system consisting of a vertical transmitter cable Trc and one induction-coil magnetometer M, the preferred embodiment has a large toroidal coil C or at least two or (which is better) a plurality of magnetometers M installed equidistantly along the circle, forming a chain, because in this case, it is possible to suppress external noise and accumulate the signal.

Two examples of a transient response function are presented in FIG. 2. The graphs show the behaviour of dB_{φ}/dt for 3 time delays (curve 1=0.5 s, curve 2=1 s and curve 3=5 s) along a profile crossing two 3D reservoirs depicted in the lower part of the figure. All three curves reveal the existence of two reservoirs and qualitatively correctly determine their location and size. Quantitative characteristics of the section can be received after additional data analysis, transformations and inversion.

FIGS. 3 and 5 present theoretical responses for two four-layer models excited by step-type pulses of a vertical current. These curves demonstrate the resolution of the proposed method and the possibility of using this method in deep and shallow water. In both cases, for sea depths of 1000 m and 300 m, the curves demonstrate good resolution: the curves for a model with oil differ by a factor of 3 from the curves without oil. Moreover, the maximal difference in signal dB_{φ}/dt is achieved for shallow depths at earlier times than for deep ones.

Apparent-resistivity curves ρ(t) corresponding to the models used in the calculation of responses demonstrated in FIGS. 3 and 5 are shown in FIGS. 4 and 6. The late-stage asymptote proposed in the real invention and used in ρ(t) calculation is:

$$ρ ( t ) = {[ \frac{{P}_{z} {σ}_{1}}{16 π \sqrt{π}} \frac{{Rh}_{0}^{2} {μ}_{0}^{7 / 2}}{{t}^{7 / 2}} \frac{1}{d {B}_{ϕ} / d t} ]}^{2 / 3}$$

Here, t is the time delay of the transient, P_{z} is the electrical moment of the transmitter cable equal to IL_{z}. Here, I is the intensity of the current; L_{z} is the length of the vertical cable. σ₁ is the specific sea-water conductivity, h is the sea depth, R is the offset, μ₀ is the magnetic permeability of vacuum.

FIGS. 4 and 6 demonstrate that the apparent-resistivity curves as well as the field responses have high resolution with respect to hydrocarbon targets for both deep and shallow water. Maximal resolution takes place in the time range of 2-4 s for shallow water and 4-6 s for deep water. The signal achieves hundreds and thousands of pT at a transmitted current of 1 kA; such a value of the total magnetic field is quite measurable by modern induction-coil magnetometers.

The specific sea-water conductivity σ₁ needed for the calculation of apparent resistivity can either be measured by a resistivity meter or be calculated from the water temperature, salinity and pressure for any depth.

The calculation of apparent resistivity based on the full transient process in a layered structure is proposed as the preferred embodiment for data presentation. This calculation is produced by a numerical way. Such a presentation has an advantage over an asymptotic one because it improves the resolution with respect to the section in an early stage of the transient process.

### REFERENCES

| | | |
|---|---|---|
| Publication No. | Published | Applicant/inventor |

US patent documents

| | | |
|---|---|---|
| 4,617,518 | October 1986 | Srnka |
| 5,563,513 | October 1996 | Tasci |
| 0052685 A1 | March 2003 | Ellingsrud et al. |
| 0048105 A1 | March 2003 | Ellingsrud et al. |
| 6,628,119 B1 | October 2003 | Eidesmo et al. |
| 7,337,064 B2 | February 2008 | MacGregor et al. |
| 2008/189042 A1 | August 2008 | Lisitsyn et al. |

Other patent documents

| | | |
|---|---|---|
| WO 01/57555 A1 | September 2001 | Ellingsrud et al. |
| WO 02/14906 A1 | February 2002 | Ellingsrud et al. |
| WO 03/025803 A1 | March 2003 | Srnka et al. |
| WO 03/034096 A1 | April 2003 | Sinha et al. |
| WO 03/048812 A1 | June 2003 | MacGregor et al. |

Norwegian patent documents

| | | |
|---|---|---|
| NO 323889 B1 G01V | 3/12 01/2006 | Barsukov et al. |

### Other Publications

Amundsen H. E. F., Johansen S. R\acute{ø}sten T.; 2004: A Sea Bed Logging (SBL) calibration survey over the Troll Gas Field. 66^{th} EAGE Conference & Exhibition, Paris, France, 6-10 Jun. 2004.
Chave A. D. and Cox C. S.; 1982: Controlled Electromagnetic Sources for Measuring Electrical conductivity Beneath the Oceans 1. Forward Problem and Model Study. Journal of geophysical Research, 87, B7, pp. 5327-5338.
Chave A. D., Constable S. C., Edwards R. N.; 1991: Electrical Exploration Methods for the Seafloor. Chapter 12. Ed. by Nabighian, Applied Geophysics, v.2, Soc. Explor. Geophysics, Tusla, Okla. pp. 931-966.
Cheesman S. J., Edwards R. N., Chave A. D.; 1987: On the theory of sea floor conductivity mapping using transient electromagnetic systems. Geophysics, V. 52, N2, pp. 204-217.
Constable S. C., Orange A. S., Hoversten G. M., Morrison H. F.; 1998: Marine magnetotellurics for petroleum exploration. Part 1: A sea floor equipment system. Geophysics, V. 63, N3, pp. 816-825.
Constable S. C., 2005: Method and system for seafloor geological survey using vertical electric field measurement, patent application publication, US 2005/0264294 A1.
Constable S. C., 2008: Three-axis marine electric field sensor for seafloor electrical resistivity measurement. Patent application publication, US 2008/0094067 A1.
Coggon J. H., Morrison. H. F.; 1970: Electromagnetic investigation of the sea floor: Geophysics, V. 35, pp. 476-489.
Edwards R. N., Law, L. K., Delaurier, J. M.; 1981: On measuring the electrical conductivity of the oceanic crust by a modified magnetometric resistivity method: J. Geophys. Res., V. 68, pp. 11609-11615.
Edwards R. N., Law L. K., Wolfgram P. A., Nobes D. C., Bone M. N., Trigg D. F., DeLaurier J. M.; 1985: First results of the MOSES experiment: Sea sediment conductivity and thickness determination. Bute Inlet, British Columbia, by magnetometric off-shore electrical sounding. Geophysics, V. 450, N1, pp. 153-160.
Edwards R. N. and Chave A. D.; 1986: On the theory of a transient electric dipole-dipole method for mapping the conductivity of the sea floor. Geophysics, V. 51, pp. 984-987.
Edwards R.; 1997: On the resource evaluation of marine gas hydrate deposits using sea-floor transient dipole-dipole method. Geophysics, V. 62, N1, pp. 63-74.
Eidesmo T., Ellingsrud S., MacGregor L. M., Constable S., Sinha M. C., Johansen S. E., Kong N. and Westerdahl, H.; 2002: Sea Bed Logging (SBL), a new method for remote and direct identification of hydrocarbon filled layers in deepwater areas. First Break, 20, March, pp. 144-152.
Ellingsrud S., Sinha M. C., Constable S., MacGregor L. M., Eidesmo T. and Johansen S. E.; 2002: Remote sensing of hydrocarbon layers by Sea Bed Logging (SBL): results from a cruise offshore Angola. The Leading Edge, 21, pp. 972-982.
Haber E., Ascher U. and Oldenburg D. W.; 2002: Inversion of 3D time domain electromagnetic data using an all-at-once approach: submitted for presentation at the 72^{nd} Ann. Internat. Mtg: Soc. of Expl. Geophys.
Howards R. N., Law L. K., Delaurier J. M.; 1981: On measuring the electrical conductivity of the oceanic crust by a modified magnetometric resistivity method: J. Geophys. Res., 86, pp. 11609-11615.
Johansen S. E., Amundsen H. E. F., Røsten T., Ellinsgrud S., Eidesmo T., Bhuyian A. H.; 2005: Subsurface hydrocarbon detected by electromagnetic sounding. First Break, V. 23, pp. 31-36.
Langel R. A., 1987: Main Field, in Geomagnetism, edited by J. A. Jacobs, Academic Press, San Diego, Calif., p. 249.
MacGregor L., Tompkins M., Weaver R., Barker N.; 2004: Marine active source EM sounding for hydrocarbon detection. 66^{th} EAGE Conference & Exhibition, Paris, France, 6-10 Jun. 2004.
Wright D. A., Ziolkowski A., and Hobbs B. A.; 2001: Hydrocarbon detection with a multichannel transient electromagnetic survey. 70^{th} Ann. Internat. Mtg., Soc. of Expl. Geophys.
Yuan J., Edward R. N.; 2004: The assessment of marine gas hydrates through electrical remote sounding: Hydrate without BSR? Geophys. Res. Lett., V. 27, N16, pp. 2397-2400.
Ziolkovsky A., Hobbs B., Wright D.; 2002: First direct hydrocarbon detection and reservoir monitoring using transient electromagnetics. First Break, V. 20, No. 4, pp. 224-225.

1. A system for the electromagnetic surveying of a hydrocarbon reservoir (Rs) below a sea floor (Sb), including a controlled-source electromagnetic transmitter (Tr) provided with a vertical transmitter cable (Trc) arranged to be submerged in a water mass (Sw) and arranged to provide an electromagnetic field by transmitting step-type current pulses (J_{Tr}), the system comprising a plurality of sea-floor receivers (M) are arranged on the sea floor (Sb) above a structure (S) that is thought or known to contain a subterranean hydrocarbon reservoir (Rs) and are arranged in such a way that a circular chain is formed, arranged to provide measurements of the time derivative of the circulation of an azimuthal component of magnetic induction excited by electrical pulses having sharp terminations provided by a pulse generator on a vertical cable arranged above the centre of the circular chain, a lower end of the cable being near the sea floor and an upper end of the cable being near the sea surface; and the system further including signal-processing means which are arranged to receive and process a signal from each of the receivers (M) and to calculate the vertical electrical field, the apparent resistivity and the resistance of the field.

2. The system according to claim 1 wherein induction-coil magnetometers arranged around the vertical transmitter cable and interconnected into a symmetrical, circular chain are used as a receiver for measuring the circulation of the azimuthal component of the magnetic induction.

3. The system according to claim 1 wherein a toroidal coil arranged on the sea floor around the vertical, transmitter cable is used as the receiver for measuring the circulation of the azimuthal component of the magnetic induction.

4. The system according to claim 1 wherein the transmitter (Tr) is mounted on a vessel and is arranged to be moved, together with the sea-floor receivers (M), from one site to another above the structure (S) that is thought or known to contain the subterranean hydrocarbon reservoir (Rs).

5. The system according to claim 1 wherein each receiver (M) includes a resistivity meter.

6. The system according to claim 2 wherein each induction-coil magnetometer is provided with a clocking device arranged in a magnetometer housing and is arranged to provide a timing signal for synchronization and for use in signal processing and stacking.

7. The system according to claim 2 wherein all the induction-coil magnetometers are connected to an optical conductor and a signal processor arranged to provide measurements of the time derivative of the circulation of the azimuthal component of the magnetic induction and measurement data collection.

8. The system according to claim 1 wherein the transmitter (Tr) is arranged to emit intermittent current pulses (J_{Tr}) having sharp edges, and the signal-processing means are arranged to provide a time derivative of magnetic field responses during a time lapse between two consecutive pulses, with accuracy sufficient to distinguish between signal responses when the structure (S) does contain a reservoir (Rs) and when the structure (S) does not contain a reservoir (Rs).

9. The system according to claim 1 wherein a radius (offset) of at least one of the sea-floor receivers (M) or a circular chain formed by the sea-floor receivers (M), the duration of current pulses and pauses are selected in combination with the intensity of the transmitting energy and the expected electrical properties of the structure (S) and the reservoir (Rs) to satisfy the validity of the near zone condition R<<\sqrt{tρₐ(t)/μ₀}, in which R is the distance (offset), t is the time delay counted from the moment after switching off the transmitter, μ₀=4π10⁻⁷ H/m; and ρₐ(t) is the apparent resistivity of the substratum in the time lapse.

10. The system according to claim 1 wherein the horizontal distance (offset) between the transmitter cable (Trc) and at least one of the sea-floor receivers (M) is within the range of 10-2000 metres.

11. The system according to claim 1 wherein the duration of the electrical current pulses falls within the range of 0.01-100 s.

12. A method for marine offshore-hydrocarbon electromagnetic prospecting, the method comprising the steps of:
arranging a plurality of sea-floor receivers (M) into a circular chain arranged to provide measurements of the time derivative of the circulation of the azimuthal component of magnetic induction excited by electric pulses having sharp termination provided by a pulse generator in a vertical cable arranged above the centre of the circular chain, a lower end of the cable being near the sea floor and an upper end of the cable being near the sea surface; and
carrying out a data-logging process for receiving and processing a signal, and calculating a vertical electrical field, the apparent resistivity and the resistance of the field.

13. The method according to claim 12 wherein induction-coil magnetometers arranged around the vertical projection of the vertical transmitter cable and interconnected in a symmetrical, circular chain are used as the receiver for measuring the circulation of the azimuthal component of the magnetic induction.

14. The method according to claim 12 wherein a toroidal coil arranged on the sea floor around the vertical projection of the vertical transmitter cable is used as the receiver for measuring the circulation of the azimuthal component of the magnetic induction.

15. The method according to claim 12 wherein the transmitter (Tr) is mounted on a vessel and, together with the sea-floor receivers (M), is arranged to be moved from one place to another above the structure (S) which is thought or known to contain the subterranean hydrocarbon reservoir (Rs).

16. The method according to claim 12 wherein each receiver (M) includes a resistivity meter.

17. The method according to claim 13 wherein each induction-coil magnetometer includes a clocking device providing an accurate timing signal for the synchronization of the induction-coil magnetometers with the transmitter (Tr) and for use in the signal processing and storing.

18. The method according to claim 13 wherein all the induction-coil magnetometers are connected to an optical conductor and a signal processor arranged to provide measurements of the time derivative of the circulation of the azimuthal component of the magnetic induction and measurement data collection.

19. The method according to claim 12 wherein the transmitter (Tr) emits intermittent current pulses having sharp edges, and the receivers (M) on the sea floor produce measurements of the medium responses during time lapses between consecutive pulses, with accuracy sufficient to distinguish between signal responses when the structure (S) does contain a reservoir (Rs) and when the structure (S) does not contain a reservoir (Rs).

20. The method according to claim 12 wherein the radius (offset) R of at least one of the sea-floor receivers (M) or a circular chain formed by the sea-floor receivers (M), the duration of the current pulses and the time lapses t are selected in combination with the intensity of the transmitting energy and the expected electrical properties of the structure (S) and reservoir (Rs) to satisfy the validity of the near zone condition R<<\sqrt{tρₐ(t)/μ₀}, in which μ₀=4π10⁻⁷ H/m, t is the time delay counted from the moment after switching off the transmitter, and ρₐ(t) is the apparent resistivity of the substratum.

21. The method according to claim 12 wherein the distance (offset) between the transmitter cable (Trc) and at least one of the sea-floor receivers (M) is within the range of 10-2000 metres.

22. The method according to claim 12 wherein the preferred duration of electrical current pulses falls within the range of 0.01-100 s.

23. The method according to claim 12 further including measurements of the sea-water resistivity.

24. The method according to claim 12 wherein the accumulated transient process of circulation of the time derivative of the azimuthal component of the magnetic field is transformed into apparent-resistivity curves using asymptotical formulas.

25. The method according to claim 12 wherein the accumulated transient process of circulation of the time derivative of the azimuthal component of the magnetic field of magnetic induction is transformed into apparent-resistivity curves using a response function calculated numerically for a normal base cross-section model with the real parameters of system configuration.

26. The method according to claim 12 wherein the time derivative of the magnetic field, its circulation and the apparent-resistivity curves are used to image 1D, 2D and 3D models of the reservoir.
